(19) United States
(12) Patent Application Publication
(10) Pub. No.: US 2022/0048263 A1
(43) Pub. Date: Feb. 17, 2022

(54) SPECTACLE MODIFICATION PROCESS AND KIT

(71) Applicants: Ross Douglas Stillwagon, Long Beach, CA (US); Shane Douglas Stillwagon, Long Beach, CA (US); Lisa Lynn Claycomb, Long Beach, CA (US); Zachary Reed Keahey, Long Beach, CA (US)

(72) Inventors: Ross Douglas Stillwagon, Long Beach, CA (US); Shane Douglas Stillwagon, Long Beach, CA (US); Lisa Lynn Claycomb, Long Beach, CA (US); Zachary Reed Keahey, Long Beach, CA (US)

(21) Appl. No.: 17/401,257

(22) Filed: Aug. 12, 2021

Related U.S. Application Data
(60) Provisional application No. 63/064,748, filed on Aug. 12, 2020.

(51) Int. Cl. B29D 11/00

(52) U.S. Cl. CPC B29D 11/00894; G02C 5/00

(57) ABSTRACT

Disclosed herein is a process to modify a pair of eyeglasses having a first color to produce a pair of modified eyeglasses having at least the portion of the frame comprising a second color. A kit to modify a pair of eyeglasses is also disclosed.

### REFERENCE TO RELATED APPLICATION

The present application claims priority to U.S. Provisional Application No. 63/064,748, filed Aug. 12, 2020, the contents of which are hereby expressly incorporated by reference herein.

### BACKGROUND

The statements in this section merely provide background information related to the present disclosure and may not constitute prior art.

Spectacles, also known as eyeglasses or simply as glasses are worn for a variety of reasons. Some spectacles are worn to shade the wearers eyes from the sun or other bright lights. Often time, a user identifies a particular style of spectacles as being preferred. Such spectacles may or may not be available in different colors. There is a need for spectacle frames which may be matched to one's apparel.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In embodiments, a process comprises the steps of providing a pair of eyeglasses having a frame comprising a first color and one or more lenses disposed at least partially within the frame; covering a front side and a rear side of each lens present with a covering material; applying one or more top coatings having a color different from the first color to at least a portion of the frame; and removing the covering material from the lens to produce a pair of modified eyeglasses having at least the portion of the frame comprising at least one second color.

In embodiments, a kit comprises a covering material suitable to cover lenses of a pair of eyeglasses having a frame comprising a first color and the one or more lenses disposed at least partially within the frame; one or more top coatings having a second color suitable for coating a portion of the frame; and a set of instructions to instruct the user to cover a front side and a rear side of each lens present with the covering material; apply one or more top coatings having a color different from the first color to at least a portion of the frame; and removing the covering material from the lens to produce a modified pair of eyeglasses having at least the portion of the frame comprising at least one second color.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The following definitions are provided in order to aid those skilled in the art in understanding the detailed description.

As used in the specification and claims, “near” is inclusive of “at.” As used herein, a “pair of eyeglasses” refers to eyewear commonly referred to as spectacles, and may include both prescription and non-prescription eyeglasses including sunglasses.

It is to be understood that for purposes herein, eyeglasses having a frame comprising a first color is not limited to a single color, but may include a plurality of colors, designs, and the like. Likewise, it is to be understood that for purposes herein, the modified eyeglasses having at least a portion of the frame comprising at least one second color is not limited to a single color, but also includes any number of colors, patterns, designs, and/or the like.

In order to match and/or color coordinate one's apparel with their eyewear, the color of the frames of their eyewear may be colored according to one or more embodiments of the process, and utilizing one or more embodiments of a corresponding kit as disclosed herein. In an embodiment, a process comprises the steps of the end user and/or another to provide a pair of eyeglasses in which the frame of the eyeglasses has a first color and/or pattern which is desired to be changed to a second color and/or pattern by the wearer. In embodiments, the eyeglasses comprise one or more lenses disposed at least partially within the frame. In an embodiment, the process includes covering the sides of the lenses i.e., a front side and a rear side of each lens present, with a covering material. In an alternative embodiment, the lenses are not present (e.g., have been removed from the frames. In still another embodiment, the coating is essentially transparent allowing for the lenses to be directly covered by the coating material. This prevents the top coating and/or other coatings from being disposed onto the lenses of the eyeglasses in an amount which occludes sight therethrough, or otherwise interferes with the used of the eyeglasses. It is to be understood that after application of the covering material to the lenses, a portion of the lenses may remain uncovered such that a portion of the coating may be disposed on a minor portion of the lenses. However, for purposes herein, the amount of the lenses affected and/or covered by the top coating does not interfere with the purpose of the eyeglasses.

In embodiments, the method includes applying one or more top coatings having a color different from the first color of the eyeglasses to at least a portion of the frame. This is followed by removing the covering material from the lens surfaces to produce a pair of modified eyeglasses having at least the portion of the frame comprising at least one second color.

In embodiments, the process further comprises the step of cleaning or otherwise preparing at least the portion of the frame to be coated prior to the applying of the one or more top coatings. This may include utilizing solvents, solvent soaked cleaning cloths, abrading the surface of the frames e.g., with sandpaper, to improve adhesion of the top coating, and the like. The cleaning and/or preparation supplies may also be included a kit for coloring eyeglass frames according to the instant method.

In embodiments, the process may further comprise one or more curing steps wherein after application of the top coating, the top coating is cured or otherwise allowed to dry by applying heat, exposing to UV radiation, air drying, or any combination thereof. In embodiments, any necessary applicators and/or curing devices may be present in a kit to accomplish this purpose.

In embodiments, the process may further include applying one or more undercoat layers to at least the portion of the frame prior to applying the one or more top coatings. In embodiments, the undercoat layer may be or may comprise a primer, a tie layer which improves adhesion of the top coating to the frame, a bonding agent or binder, a leveling agent, or any combination thereof. In embodiments, the undercoat may be a primer which provides a uniform surface over which the top coating is applied. The primer may provide a smooth surface, a uniform colored surface, and/or the like which improves the overall appearance of the final product.

The top coating and/or the undercoat can include one or more organic polymers that are film forming and can be formed as a suspension or emulsion or in solution. It can include polymers that are not crosslinking and to which additional crosslinking agents are not added, or it can include polymer to which crosslinking agents are added and are thus capable of being crosslinked under appropriate conditions.

Useful polymer binders include, but are not limited, to poly(vinyl alcohol), poly(vinyl pyrrolidone), ethylene oxide polymers, polyurethanes, urethane-acrylic copolymers, other acrylic polymers, styrene-acrylic copolymers, vinyl polymers, and polyesters, silicone polymers or combinations of two or more of these organic polymers. Such polymer binders are readily available from various commercial sources or can be prepared using known starting materials and synthetic conditions. The polymer binder can be anionic, cationic or nonionic in total charge. A useful class of film-forming polymer binders includes aqueous latex polymer dispersions such as acrylic latexes that can be ionic or nonionic colloidal dispersions of acrylate polymers and copolymers. Film-forming aqueous latexes suitable for use include styrene-butadiene latexes, poly(vinyl chloride) and poly(vinylidene chloride) latexes, poly(vinyl pyridine) latexes, and poly(acrylonitrile) latexes.

In some embodiments the polymer binder has a glass transition temperature Tg that is less than about 25° C., and typically is less than about 0° C. in order to make the coating flexible and crack-free. However, in other embodiments, e.g., for hard coat applications, the polymer binder preferably has a glass transition temperature Tg that is above about 70° C.

In embodiments, the polymer binder can optionally be crosslinked with a crosslinking agent which may be activated chemically with heat, optically via UV radiation, upon exposure to air, or by other means in order to provide enhanced integrity and wash durability of the resulting modified eyeglasses. The crosslinking agent may further serve to provide improved insolubility of other top coats to in the underlying layer. The crosslinking agent is a chemical having functional groups capable of reacting with reactive sites on the polymer under curing conditions to thereby produce a crosslinked structure. Examples of suitable crosslinking agents include multi-functional aziridines, aldehydes, and epoxides.

In embodiments, the coating may include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene. It is to be understood that the above listing is exemplary and not to be construed as limiting to the coating. Accordingly, the coating may include any suitable material presently known or which is yet to be discovered or developed.

Additionally, the coatings may include additives such as fillers; antioxidants (e.g., hindered phenolics such as IRGANOX 1010 or IRGANOX 1076 available from Ciba-Geigy); phosphites (e.g., IRGAFOS 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; and the like.

Drying and optional crosslinking of the polymer binder can be accomplished by suitable means such as by heating, and various mechanisms can be employed for crosslinking the polymer binder. For example, the crosslinking can involve condensation or addition reactions promoted by heat or radiation. In one embodiment, an undercoat composition is used as the polymer binder. Upon heating, the film dries, with a crosslinking reaction taking place between the reactive side groups of the polymer chains. If the particular polymer used is not itself heat reactive, then suitable catalysts or crosslinking agents can be added to promote crosslinking upon heating.

In embodiments, the at least one or more top coatings is applied as an aerosol followed by curing to produce the at least one top coating. Examples include various forms of coatings typically referred to as spray paints which cure due to evaporation of a suitable solvent, e.g., a C₁-C₅ hydrocarbon, fluorocarbon, a polysiloxane, and/or the like, including lacquers, epoxy, latex, polyesters, polyimides, and the like. In embodiments, the top coating comprises a pigment, a dye, or a combination thereof.

In embodiments, the at least one top coating comprises cellulose and/or an alkyl ester derivative of cellulose. In embodiments, the alkyl ester comprises from 2 to 10 carbons, or from 2 to 6 carbons, or from 2 to 4 carbons. Examples include cellulose acetate, cellulose propionate, cellulose butyrate, cellulose hexanoate, cellulose octanoate. In embodiments the top coating may comprise cellulose functionalized with a plurality of functional groups, e.g., cellulose acetate propionate, cellulose acetate butyrate, and/or the like, wherein at least a portion of the cellulose comprises a plurality of different functional groups. Examples include cellulose acetate butyrate, which comprises cellulose having both acetate and butyrate functional groups.

In embodiments, at least one top coating and/or at least one undercoating is applied by dipping at least a portion of the frame into a liquid formulation comprising the components of the respective coating, removing the excess liquid formulation from the coated frames, followed by curing of the liquid formulation to produce the at least one top coating and/or undercoating. In still other embodiments, at least one top coating and/or undercoating is applied as a powder coat to the frame, followed by curing of the powder coat to produce the respective coating.

Prior to applying any coating to the frames, the lenses must be at least partially covered to prevent one or more of the coatings from occluding vision. In embodiments, the covering material is an adhesive backed laminate. Suitable laminates include various types of tapes and other polymeric substrates that can be applied and then removed from the lenses after application of the top coating. In embodiments, the lens cover may be premade to approximate a particular lens shape and provided in a “peel and stick” format within a kit.

In an alternative embodiment, or in addition to the peel and stick covering material, the covering material may be a liquid, a semi-solid, a wax, a gum, a gel, or a combination thereof. In such embodiments, the liquid may have an adequate viscosity to allow for deposition onto the lenses, which may be subsequently cured so as to remain in place during the coating process. In embodiments, the coating material may be a relatively low melting semi-solid, wax, gum, and/or gel, which melts at about 30° C. or higher, preferably at about 30° C. or higher and to about 50° C., and then freezes or otherwise solidifies at room temperature and below such that the coating material may be slightly heated, applied to the lenses as a liquid, and then cooled to form a removably, solid or semi-solid coating over the lenses.

In alternative embodiments, the coating material is a gel, e.g., a petroleum gel, which may be applied to the lenses and subsequently removed after the coating process. In an embodiment, the coating material is water soluble and/or water dispersible so as to facilitate removal of the coating material from the surface of the lenses after the top coating has been applied to the frame.

In still other embodiments, the coating material is dissolved in a solvent and applied to the lenses as a liquid. The solvent is then evaporated e.g., “air dried”, to form a removable, protective coating over the lenses which is subsequently removed after the coating process. In still other embodiments, the protective coating is a polymeric film which is applied to the lenses, trimmed to fit, and then removed once the coating has been applied.

In embodiments, the applying of one or more top coatings comprises applying a plurality of top coatings, at least two top coatings having a color which is different from one another. In such an embodiment, the blending of the various colors results in a lens frame having a plurality of colors, and/or a single color resultant from the plurality of coatings.

In embodiments, the process further comprises applying one or more clear coats on top of the top coating. Such clear coats may have a hardness, a sheen, and/or other properties which protect the top coating and/or which result in an aesthetically pleasing result. In some embodiments, the clear coat results in an essentially clear coating. In related embodiments, the clear coat results in an essentially clear and colorless coating.

In embodiments, a kit comprises the necessary materials and instructions to modify a pair of eyeglasses according to one or more embodiments disclosed herein. In an embodiment, a kit comprises a covering material suitable to cover lenses of an eyeglass frame having a first color; one or more top coatings having a second color suitable for coating a portion of the eyeglass frame; and a set of instructions to instruct the user to cover a front side and a rear side of each lens present with the covering material; apply one or more top coatings having a color different from the first color to at least a portion of the frame; and removing the covering material from the lens to produce a modified pair of eyeglasses having at least the portion of the frame comprising at least one second color.

### Embodiments Listing

Accordingly, the instant disclosure provides the following embodiments:

E1. A process comprising:
providing a pair of eyeglasses having a frame comprising a first color and one or more lenses disposed at least partially within the frame;
covering a front side and a rear side of each lens present with a covering material;
applying one or more top coatings having a color different from the first color to at least a portion of the frame; and
removing the covering material from the lens to produce a pair of modified eyeglasses having at least the portion of the frame comprising at least one second color.
   E2. The process of embodiment E1, further comprising cleaning of at least the portion of the frame prior to the applying of the one or more top coatings.
   E3. The process of embodiment E1 or E2, further comprising curing of the one or more top coatings by applying heat, exposing to UV radiation, air drying, or a combination thereof.
   E4. The process of any one of embodiment E1 through E3, further comprising applying one or more undercoat layers to at least the portion of the frame prior to applying the one or more top coatings.
   E5. The process of embodiment E4, wherein the undercoat layer comprises a primer, a tie layer, a bonding agent, or a combination thereof.
   E6. The process of any one of embodiment E1 through E5, wherein at least one top coating is applied as an aerosol followed by curing to produce the at least one top coating.
   E7. The process of any one of embodiment E1 through E6, wherein at least one top coating is applied by dipping at least a portion of the frame into a liquid, removing excess liquid, followed by curing of the liquid to produce the at least one top coating.
   E8. The process of any one of embodiment E1 through E7, wherein at least one top coating is applied as a powder coat to the frame, followed by curing of the powder to produce the at least one top coating.
   E9. The process of any one of embodiment E1 through E8, wherein the covering material is an adhesive backed laminate.
   E10. The process of any one of embodiment E1 through E9, wherein the covering material is a liquid, a semi-solid, a wax, a gum, a gel, or a combination thereof.
   E11. The process of embodiment E10, wherein the covering comprises applying the covering material to a corresponding side of the lens as a liquid and further comprises curing the covering material to form a solid, a semi-solid, a gum, a gel, or a combination thereof.
   E12. The process of any one of embodiment E1 through E11, wherein the top coating comprises a pigment, a dye, or a combination thereof.
   E13. The process of any one of embodiment E1 through E12, wherein the applying one or more top coatings comprises applying a plurality of top coatings, at least two top coatings having a color which is different from one another.
   E14. The process of any one of embodiment E1 through E13, further comprising applying one or more clear coats on top of the top coating, wherein each clear coat is essentially clear, or essentially clear and colorless.
   E15. The process of any one of embodiment E1 through E14, wherein at least one of the top coatings comprises cellulose, and/or an alkyl ester derivative of cellulose.
   E16. The process of any one of embodiment E1 through E15, wherein at least one of the top coatings comprises cellulose acetate, cellulose propionate, cellulose butyrate, cellulose acetate propionate, cellulose acetate butyrate, or a combination thereof.
   E17. A kit comprising necessary components to modify a pair of eyeglasses according to any one of embodiments E1 through E16, and a set of instructions sufficient to instruct a user to modify the pair of eyeglasses according to any one of embodiments E1 through E16.
   E18. A kit comprising:
a covering material suitable to cover lenses of an eyeglass frame having a first color;
one or more top coatings having a second color suitable for coating a portion of the eyeglass frame; and
a set of instructions to instruct the user to cover a front side and a rear side of each lens present with the covering material;
apply one or more top coatings having a color different from the first color to at least a portion of the frame; and
removing the covering material from the lens to produce a modified pair of eyeglasses having at least the portion of the frame comprising at least one second color.
   E19. The kit according to any one of embodiment E17 or E18, wherein at least one top coating comprises cellulose, and/or an alkyl ester derivative of cellulose.
   E20. The kit according to any one of embodiment E17 through E19, wherein at least one of the top coatings comprises cellulose acetate, cellulose propionate, cellulose butyrate, cellulose acetate propionate, cellulose acetate butyrate, or a combination thereof.

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A process comprising:
providing a pair of eyeglasses having a frame comprising a first color and one or more lenses disposed at least partially within the frame;
covering a front side and a rear side of each lens present with a covering material;
applying one or more top coatings having a color different from the first color to at least a portion of the frame; and
removing the covering material from the lens to produce a pair of modified eyeglasses having at least the portion of the frame comprising at least one second color.

2. The process of claim 1 further comprising cleaning of at least the portion of the frame prior to the applying of the one or more top coatings.

3. The process of claim 1, further comprising curing of the one or more top coatings by applying heat, exposing to UV radiation, air drying, or a combination thereof.

4. The process of claim 1, further comprising applying one or more undercoat layers to at least the portion of the frame prior to applying the one or more top coatings.

5. The process of claim 4, wherein the undercoat layer comprises a primer, a tie layer, a bonding agent, or a combination thereof.

6. The process of claim 1, wherein at least one top coating is applied as an aerosol followed by curing to produce the at least one top coating.

7. The process of claim 1, wherein at least one top coating is applied by dipping at least a portion of the frame into a liquid, removing excess liquid, followed by curing of the liquid to produce the at least one top coating.

8. The process of claim 1, wherein at least one top coating is applied as a powder coat to the frame, followed by curing of the powder coat to produce the at least one top coating.

9. The process of claim 1, wherein the covering material is an adhesive backed laminate.

10. The process of claim 1, wherein the covering material is a liquid, a semi-solid, a wax, a gum, a gel, or a combination thereof.

11. The process of claim 10, wherein the covering comprises applying the covering material to a corresponding side of the lens as a liquid and further comprises curing the covering material to form a solid, a semi-solid, a gum, a gel, or a combination thereof.

12. The process of claim 1, wherein the top coating comprises a pigment, a dye, or a combination thereof.

13. The process of claim 1, wherein the applying one or more top coatings comprises applying a plurality of top coatings, at least two top coatings having a color which is different from one another.

14. The process of claim 1, further comprising applying one or more clear coats on top of the top coating, wherein each clear coat is essentially clear, or essentially clear and colorless.

15. The process of claim 1, wherein at least one of the top coatings comprises cellulose, and/or an alkyl ester derivative of cellulose.

16. The process of claim 1, wherein at least one of the top coatings comprises cellulose acetate, cellulose propionate, cellulose butyrate, cellulose acetate propionate, cellulose acetate butyrate, or a combination thereof.

17. A kit comprising:
a covering material suitable to cover lenses of an eyeglass frame having a first color;
one or more top coatings having a second color suitable for coating a portion of the eyeglass frame; and
a set of instructions to instruct the user to cover a front side and a rear side of each lens present with the covering material;
apply one or more top coatings having a color different from the first color to at least a portion of the frame; and
removing the covering material from the lens to produce a modified pair of eyeglasses having at least the portion of the frame comprising at least one second color.

18. The kit of claim 17, wherein at least one top coating comprises cellulose, and/or an alkyl ester derivative of cellulose.

19. The kit of claim 17, wherein at least one of the top coatings comprises cellulose acetate, cellulose propionate, cellulose butyrate, cellulose acetate propionate, cellulose acetate butyrate, or a combination thereof.
